(19) United States
(12) Patent Application Publication
(10) Pub. No.: US 2007/0150931 A1
(43) Pub. Date: Jun. 28, 2007

(54) Device and method for receiving VBI data broadcast

(75) Inventor: Yusuke Nishida, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/645,619

(22) Filed: Dec. 27, 2006

(30) Foreign Application Priority Data
Dec. 28, 2005 (JP) 2005-377992

(51) Int. Cl. H04N 7/16; H04N 11/00

(52) U.S. Cl. 725/136; 348/465; 348/468

(57) ABSTRACT

A method for extracting VBI data includes the steps of memorizing a preset start time of extracting the VBI data, turning on power of the data broadcast reception device before it becomes the start time of extracting the VBI data, making a primary display indicating that the data broadcast reception device is powered on for extracting the VBI data, performing an activation process of the data broadcast reception device, making a secondary display indicating that the activation process is completed, tuning for receiving a television signal, demodulating the received television signal, and extracting the VBI data superimposed on the video signal of the demodulated television signal during the VBI.

This application is based on Japanese Patent Application No. 2005-377992 filed on Dec. 28, 2005, the contents of which are hereby incorporated by reference.

### BACKGROUND OF THE INVENTION

1. Field of the Invention

The present invention relates to a data broadcast reception device that extracts VBI data that is data superimposed on a television signal during the VBI (Vertical Blanking Interval), a hard disk recorder for recording the extracted VBI data and a method for extracting VBI data.

2. Description of Related Art

The VBI data that is data superimposed on a television signal during a VBI (Vertical Blanking Interval) is utilized for data broadcasting that delivers contents such as an EPG (Electronic Program Guide) or a caption broadcast.

The data broadcast is delivered as data superimposed on a television signal during VBI of a predetermined frequency (channel). The contents to be delivered include the EPG; news, weather forecast and the like. The contents are not delivered every time but are delivered once or several times a day during predetermined time periods.

The data broadcast reception device can receive a television broadcast and extract VBI data superimposed on a video signal included in the television broadcast during the VBI. The data broadcast reception device is automatically powered on to start for obtaining contents desired by the user when it becomes the time of delivering the contents. At this time, driving sounds are generated in a recording device, a cooling fan or the like, so that the user can recognize that the data broadcast reception device is powered on. In addition, when the data broadcast reception device is powered on automatically for extracting the VBI data, a display portion makes a display indicating that the data broadcast reception device is powered on for extracting the VBI data.

For example, a conventional device described in JP-A-11-275539 receives the VBI data superimposed during the VBI, detects identification information for identifying the received VBI data, and turns on the system if the VBI data match the detected identification information.

When the data broadcast reception device is activated for operation, it makes a display indicating that the system is activated for receiving the data broadcast on a front display. However, during the activation process of each portion of the data broadcast reception device, the VBI data cannot be received, which means that the state where the system cannot extract the VBI data continues during the period while the activation process is performed even though the power is turned on. Therefore, the user may misunderstand that the data broadcast reception device is broke down or is in the wrong state where the VBI data cannot be extracted.

Furthermore, in a manufacturing process of the data broadcast reception device, an inspection of the VBI data extraction function is performed. In the inspection step, a television signal including a video signal on which the VBI data extraction test data are superimposed during the VBI is received by the data broadcast reception device, so that the VBI data included in the television signal is extracted. In this case, it is difficult to know the timing for transmitting the television broadcast on which the VBI data extraction test data is superimposed, so it is necessary to secure sufficient delay time from turn-on of the data broadcast reception device until transmission of the television broadcast. Otherwise, the data broadcast reception device may fail in obtaining the VBI data in this inspection, and in that case it is difficult to specify the cause of the failure, i.e., whether the problem is in the data broadcast reception device or in the transmitted television signal or in other part.

In the above-mentioned device described in JP-A-11-275539, a VBI extraction portion and a VBI monitoring portion are working normally for receiving data transmitted by utilizing the VBI. In this case, it is difficult for the user to check whether the data broadcast reception device is working or not.

### SUMMARY OF THE INVENTION

An object of the present invention is to provide a data broadcast reception device that is capable of indicating a user securely that a system is turned on for extracting VBI data and a state of extracting the VBI data.

Another object of the present invention is to enable a television signal for extraction test of the VBI data to be transmitted at an appropriate timing in a manufacturing inspection step of the data broadcast reception device.

A data broadcast reception device according to an aspect of the present invention is a device for extracting VBI data superimposed on a received television signal during the VBI. The device includes a tuning portion for receiving a television signal, a demodulating portion for demodulating the television signal received by the tuning portion, a signal processing portion for extracting VBI data superimposed on a video signal included in the television signal demodulated by the demodulating portion during a VBI, a primary display portion for making a primary display indicating that the data broadcast reception device is powered on for receiving the television signal and extracting the VBI data, a secondary display portion for making a secondary display indicating that the data broadcast reception device has become a state ready to extract the VBI data, a memory portion for memorizing a start time of extracting the VBI data, and a controller unit for controlling the portions. The controller unit turns on the data broadcast reception device before it becomes the start time of extracting the VBI data memorized in the memory portion, lets the primary display portion make the primary display, performs an activation process of the portions, lets the secondary display portion make the secondary display after the activation process is completed, and lets the signal processing portion start extraction of the VBI data.

According to this structure, the primary display is made by the primary display portion for indicating that the data broadcast reception device is powered on for extracting the VBI data superimposed on the received video signal during the VBI, and the secondary display is made by the secondary display portion for indicating that the activation process of the data broadcast reception device is completed so that the device has become the state ready to extract the VBI data. Therefore, the user can recognize that the data broadcast reception device is powered on automatically for extracting the VBI data and that the device has becomes the state ready to extract the VBI data visually and individually.

Thus, it is possible to provide a data broadcast reception device that is capable of indicating a user securely that a power is turned on for extracting the VBI data and a state of extracting the VBI data.

In addition, since the secondary display is made, a timing for transmitting the television signal for the VBI data extraction test can be adjusted to the timing when the data broadcast reception device becomes the state ready to extract the VBI data in the manufacturing inspection step of the data broadcast reception device.

Thus, when the television signal for the VBI data extraction test is transmitted, it can be transmitted with a delay time that is minimized. In addition, it is possible to avoid a necessity of retransmission when the transmission timing was too early.

In a preferred embodiment of the present invention, the data broadcast reception device further includes a recording device for recording the VBI data extracted by the signal processing portion on a recording medium. After the secondary display portion makes the secondary display, the signal processing portion extracts the VBI data, while the recording device records the VBI data on the recording medium.

A hard disk recorder according to another aspect of the present invention is a hard disk recorder for extracting and recording VBI data superimposed on a received television signal during the VBI. The hard disk recorder includes a tuning portion for receiving a television signal, a demodulating portion for demodulating the television signal received by the tuning portion, a signal processing portion for extracting VBI data superimposed on a video signal included in the television signal demodulated by the demodulating portion during a VBI, a recording device for recording the extracted the VBI data in a hard disk that is a recording medium, a primary display portion for making a primary display indicating that the hard disk recorder is powered on for receiving the television signal and extracting the VBI data, a secondary display portion for making a secondary display indicating that the hard disk recorder has become a state ready to extract and record the VBI data, a memory portion for memorizing a start time of extracting the VBI data preset by a user, and a controller unit for controlling the portions. The controller unit turns on power of the hard disk recorder before it becomes the start time of extracting the VBI data memorized in the memory portion, lets the primary display portion make the primary display, performs an activation process of the portions, lets the secondary display portion make the secondary display after the activation process is completed, and lets the signal processing portion start extraction of the VBI data so that the recording device records the VBI data.

A method according to still another aspect of the present invention is a method for extracting VBI data superimposed on a received television signal during the VBI in a data broadcast reception device. The method includes a memorizing step for memorizing a preset start time of extracting the VBI data, a power on step for turning on power of the data broadcast reception device before it becomes the start time of extracting the VBI data memorized in the memorizing step, a primary display step for making a primary display indicating that the data broadcast reception device is powered on for receiving the television signal and extracting the VBI data, an activation step for performing an activation process of the data broadcast reception device, a secondary display step for making a secondary display indicating that the activation process of the data broadcast reception device is completed, a tuning step for receiving a television signal, a demodulating step for demodulating the received television signal, and a signal processing step for extracting the VBI data superimposed on the video signal of the demodulated television signal during the VBI.

In a preferred embodiment of the present invention, the method further includes a recording step for recording the VBI data extracted in the signal processing step on a recording medium.

A method according to still another aspect of the present invention is a method for extracting and recording VBI data superimposed on a received television signal during the VBI in a hard disk recorder. The method includes a memorizing step for memorizing a start time of extracting the VBI data preset by a user, a power on step for turning on power of the hard disk recorder before it becomes the start time of extracting the VBI data memorized in the memorizing step, a primary display step for making a primary display indicating that the hard disk recorder is powered on for receiving the television signal and extracting the VBI data, an activation step for performing an activation process of the hard disk recorder, a secondary display step for making a secondary display indicating that the activation process of the hard disk recorder is completed, a tuning step for receiving a television signal, a demodulating step for demodulating the received television signal, a signal processing step for extracting the VBI data superimposed on the video signal of the demodulated television signal during the VBI, and a recording step for recording the extracted the VBI data in a hard disk that is a recording medium.

According to the present invention, the secondary display portion makes the display securely indicating that the data broadcast reception device is powered on for extracting the VBI data superimposed on the video signal during the VBI and that the data broadcast reception device is ready to obtain the VBI data. Therefore, the user can know that the data broadcast reception device is receiving the VBI data securely. Furthermore, in the manufacturing inspection step of the data broadcast reception device, the television signal for the VBI data extraction test can be transmitted at an appropriate timing.

### BRIEF DESCRIPTION OF THE DRAWINGS

FIG. 1 is a block diagram of a data broadcast reception device according to the present invention.

FIG. 2 is a flowchart of a method for receiving a data broadcast in the data broadcast reception device shown in FIG. 1.

FIG. 3 is a block diagram of a hard disk recorder that is an example of the data broadcast reception device according to the present invention.

FIG. 4 is a flowchart of a method for receiving a data broadcast in the hard disk recorder shown in FIG. 3.

### DESCRIPTION OF THE PREFERRED EMBODIMENTS

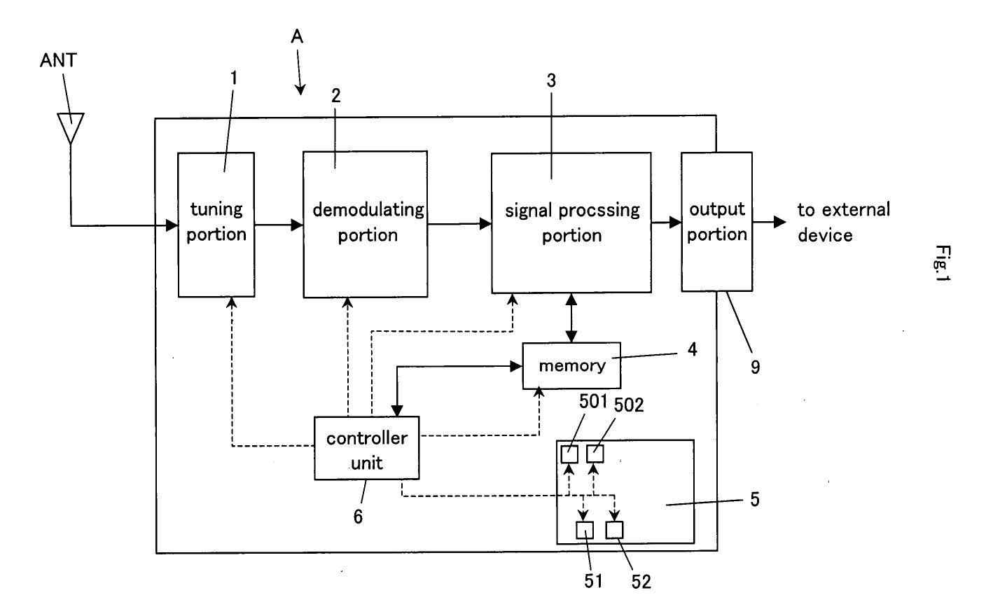

Now, an embodiment of the present invention will be described with reference to the attached drawings. FIG. 1 is a block diagram of a data broadcast reception device according to the present invention. The data broadcast reception device A shown in FIG. 1 includes a tuning portion 1, a demodulating portion 2, a signal processing portion 3, a memory 4, a display portion 5, a controller unit 6, and an output portion 9.

The tuning portion 1 receives a television signal of a tuned channel via an antenna ANT, and the received television signal that is a high frequency signal is converted into an intermediate frequency signal (IF signal). The intermediate frequency signal includes a video IF signal and an audio IF signal. The demodulating portion 2 demodulates the intermediate frequency signal outputted from the tuning portion 1. The demodulated signal includes a video signal and an audio signal.

The signal processing portion 3 processes the signal outputted from the demodulating portion 2 and extracts VBI data that is superimposed on the video signal during the VBI.

The memory 4 is a storage medium for storing various data kept by the data broadcast reception device A, and a writable RAM (Random Access Memory) or the like is used for the memory 4, for example.

The display portion 5 has a function of indicating a current state of the data broadcast reception device A to a user. The display portion 5 includes a data broadcast display portion 51 for making a primary display indicating that the data broadcast reception device A is powered on for extracting the VBI data and a VBI data extraction display portion 52 for making a secondary display indicating that the signal processing portion 3 is in a state ready to extract the VBI data. Other than those, a stand-by state display portion 501 indicating to be a stand-by state and a time display portion 502 for making a time display are provided. Furthermore, it is possible to provide other state display portion in accordance with operations of the data broadcast reception device A.

The controller unit 6 is a central processing unit (CPU) for controlling the portions of the data broadcast reception device A and performing operations of data or the like. A microprocessor is used as the controller unit 6, for example.

The output portion 9 is an output interface for outputting the signal from the signal processing portion 3 to a CRT or other external devices.

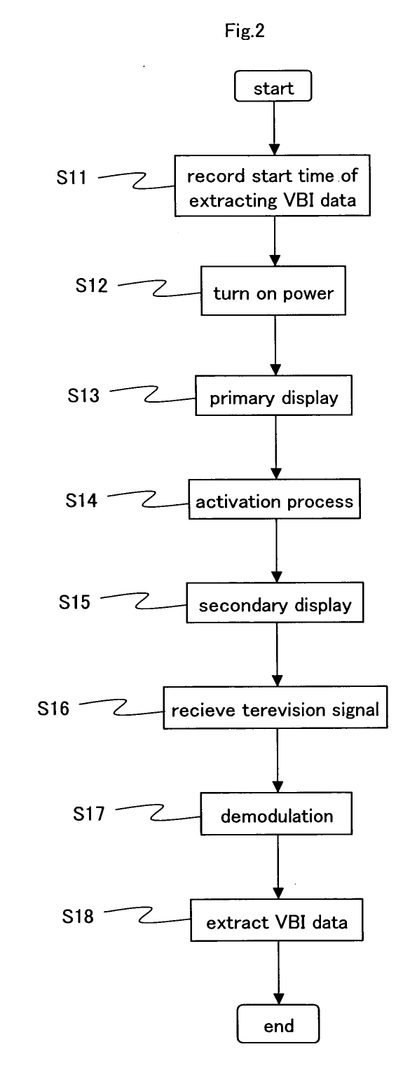

A flowchart of a process for extracting the VBI data in the data broadcast reception device A described above is shown in FIG. 2. The controller unit 6 obtains a start time of extracting the VBI data for obtaining contents desired by the user (for example, an electronic program guide, a weather forecast, traffic information or the like) and records the start time of extracting the VBI data in the memory 4 (Step S11). Note that the start time of extracting the VBI data is obtained via a keyboard or a remote controller (not shown), or via the Internet or the like. The controller unit 6 reads out the start time of extracting the VBI data recorded in the memory 4 and turns on power of the data broadcast reception device A as the start time for extraction approaches (a predetermined time period before it) (Step S112). Therefore, the controller unit 6 has a real time clock.

When the data broadcast reception device A is powered on in Step S12, the controller unit 6 gives an instruction to the data broadcast display portion 51 of the display portion 5 and lets the data broadcast display portion 51 make the primary display indicating that the data broadcast reception device A is powered on for extracting the VBI data (Step S13).

When the data broadcast reception device A is powered on, the controller unit 6 performs an activation process of the portions of the data broadcast reception device A (Step S14). The activation process is a process for checking connection states of the portions including the tuning portion 1, the signal processing portion 3 and the memory 4, checking operations of them, and checking that the data broadcast reception device A can work normally.

There is a case where this activation process is extended to a longer time period depending on the connection state of the connected portions or the like. In this case, the data broadcast reception device A cannot receive the television broadcast so that the VBI data are not extracted during the period.

When the activation process of the data broadcast reception device A is started, a cooling fan (not shown) starts to rotate for cooling the inside of the device. Therefore, the user can recognize that the data broadcast reception device A is powered on automatically. In addition, since the data broadcast display portion 51 makes the primary display, the user can recognize that the data broadcast reception device A is powered on for extracting the VBI data.

When the activation process (Step S14) of the data broadcast reception device A is finished, the controller unit 6 gives an instruction to the VBI data extraction display portion 52 of the display portion 5 and lets the VBI data extraction display portion 52 make the secondary display indicating that the device has become ready to extract the VBI data (Step S15). At this time point, the data broadcast reception device A becomes ready to receive the television broadcast. The tuning portion 1 receives the television signal via the antenna, and the received television signal that is a high frequency signal is converted into an intermediate frequency signal (IF signal) (Step S16).

The intermediate frequency signal outputted from the tuning portion 1 is demodulated by the demodulating portion 2 (Step S17). The signal outputted from the demodulating portion 2 includes a video signal and an audio signal. The video signal included in the signal outputted from the demodulating portion 2 is sent to the signal processing portion 3, which extracts the VBI data superimposed on the video signal during the VBI (Step S18).

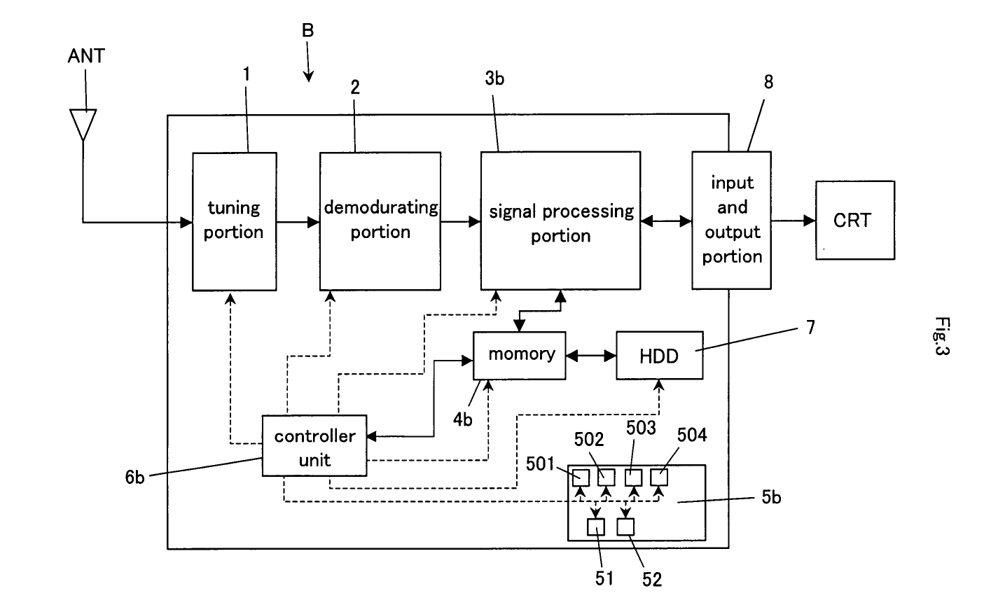

FIG. 3 is a block diagram showing a data broadcast reception device according to another embodiment of the present invention. The data broadcast reception device shown in FIG. 3 is a hard disk recorder, but the present invention is not limited to such an application. The hard disk recorder B shown in FIG. 3 is equipped with a tuning portion 1, a demodulating portion 2, a signal processing portion 3b, a memory 4b, a display portion 5b, a controller unit 6b, a hard disk drive 7, and an input and output portion 8. In addition, the input and output portion 8 is connected to a CRT as an external display device. The tuning portion 1 and the demodulating portion 2 are the same as the tuning portion 1 and the demodulating portion 2 of the data broadcast reception device A shown in FIG. 1.

The tuning portion 1 receives a television signal of a tuned channel via an antenna ANT and converts the received television signal that is a high frequency signal into an intermediate frequency signal (IF signal). The intermediate frequency signal includes a video IF signal and an audio IF signal. The demodulating portion 2 demodulates the intermediate frequency signal outputted from the tuning portion 1. The demodulated signal includes a video signal and an audio signal.

The signal processing portion 3b processes the signal outputted from the demodulating portion 2 and extracts the VBI data superimposed on the video signal during the VBI. Furthermore, the signal processing portion 3b is equipped with an A/D converter and an encoder (not shown) for converting the video signal and the audio signal into data that can be recorded in the hard disk drive 7 (for example, MPEG coded data), as well as a decoder and a D/A converter (not shown) for converting the data recorded in the hard disk drive 7 into a video signal and an audio signal that can be reproduced by the external display device such as a CRT. In addition, the signal processing portion 3b is connected to the input and output portion 8.

The memory 4b is a storage medium for memorizing temporarily various types of data stored in the hard disk recorder B, and a writable RAM (Random Access Memory) or the like is used as the memory 4b. The memory 4b is used as a buffer memory for memorizing temporarily various types of data.

The display portion 5b has a function of indicating a current state of the hard disk recorder B to the user. The display portion 5b includes a data broadcast display portion 51 for making a primary display indicating that the hard disk recorder B is powered on for extracting the VBI data and a VBI data extraction display portion 52 for making a secondary display indicating that the signal processing portion 3b is in the state ready to extract the VBI data and to record the extracted VBI data in the hard disk drive 7. Other than those, a stand-by state display portion 501 indicating to be a stand-by state, a time display portion 502 for making a time display, a reproducing state display portion 503 indicating that contents recorded in the hard disk drive 7 is being reproduced, and a reservation display portion 504 indicating that a time is designated for recording reservation are provided. Furthermore, it is possible to provide other state display portion in accordance with operations of the hard disk recorder B.

The controller unit 6b is a central processing unit (CPU) for controlling the portions of the hard disk recorder B and performing operations of data or the like. A microprocessor is used as the controller unit 6b, for example.

The hard disk drive 7 is a recording device for recording data of the video signal and the audio signal processed in the signal processing portion 3b and various preset data.

The input and output portion 8 is an input and output interface for input and output of an analog signal or digital data from or to an external display device such as a CRT. Note that the input and output portion 8 is equipped with a D/A converter and an A/D converter (not shown) for either the analog signal or the digital data can be inputted and outputted in accordance with the external display device such as a CRT.

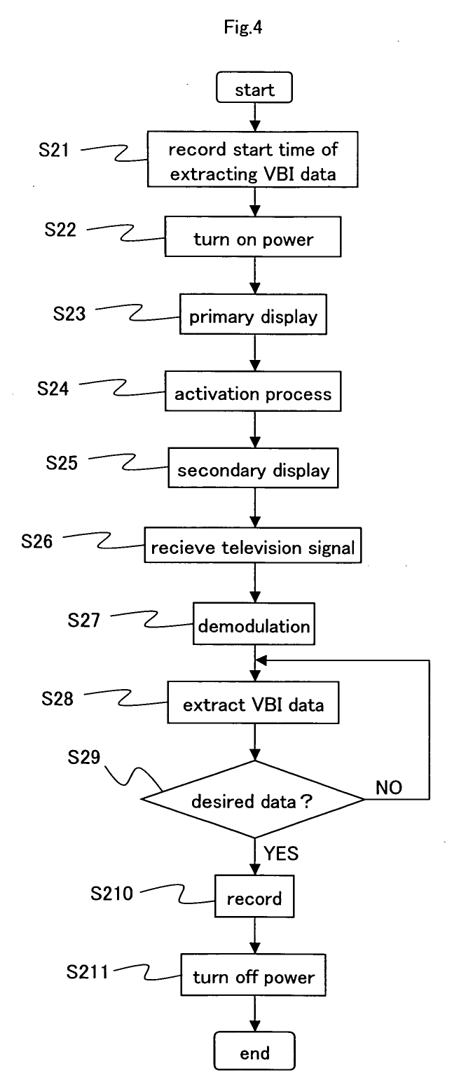

A flowchart of a process for extracting the VBI data in the hard disk recorder described above is shown in FIG. 4. The start time of extracting the VBI data for obtaining contents desired by the user (for example, an electronic program guide, a weather forecast, traffic information or the like) is preset. The controller unit 6b records the start time of extracting the VBI data in the memory 4b of the hard disk recorder B (Step S21). Note that the start time of extracting the VBI data is obtained via a keyboard or a remote controller (not shown) provided to the hard disk recorder B, or via the Internet or the like. The controller unit 6b reads out the start time of extracting the VBI data recorded in the memory 4b and turns on power of the hard disk recorder B as the start time for extraction approaches (a predetermined time period before it) (Step S22).

When the hard disk recorder B is powered on in Step S22, the controller unit 6b gives an instruction to the data broadcast display portion 51 of the display portion 5b and lets the data broadcast display portion 51 make the primary display indicating that the hard disk recorder B is powered on for extracting the VBI data (Step S23).

When the hard disk recorder B is powered on, the controller unit 6b performs an activation process of the portions of the hard disk recorder B (Step S24). The activation process is a process for checking connection states of the portions including the hard disk drive 7, the memory 4b and the signal processing portion 3b, checking operations of them, and checking that the hard disk recorder B can work normally.

There is a case where this activation process is extended to a longer time period depending on a storage capacity of the connected hard disk drive 7, the memory 4b and the like, the connection state of the connected portions or the like. In this case, the hard disk recorder B cannot receive the television broadcast so that the VBI data are not extracted during the period.

When the activation process of the hard disk recorder B is started, a cooling fan (not shown) starts to rotate for cooling the inside of the device, and a driving sounds of the hard disk 7 are generated. Therefore, the user can recognize that the hard disk recorder B is powered on automatically. In addition, since the data broadcast display portion 51 makes the primary display, the user can recognize that the hard disk recorder B is powered on for extracting the VBI data.

When the activation process (Step S24) of the hard disk recorder B is finished, the controller unit 6b gives an instruction to the VBI data extraction display portion 52 of the display portion 5b and lets the VBI data extraction display portion 52 make the secondary display indicating that the device has become ready to extract the VBI data (Step S25). At this time point, the hard disk drive B becomes ready to receive the television broadcast. The controller unit 6b gives an instruction to the tuning portion 1, and the tuning portion 1 receives the television signal via an antenna. The received television signal that is a high frequency signal is converted into an intermediate frequency signal (IF signal) (Step S26).

The intermediate frequency signal outputted from the tuning portion 1 is demodulated by the demodulating portion 2 (Step S27). The signal outputted from the demodulating portion 2 includes a video signal and an audio signal. The video signal included in the signal outputted from the demodulating portion 2 is sent to the signal processing portion 3b, which extracts the VBI data superimposed on the video signal during the VBI (Step S28). The controller unit 6b checks whether or not the extracted VBI data are contents desired by the user (Step S29).

If the VBI data are not the contents desired by the user (in the case of NO in Step S29), the controller unit 6b extracts VBI data until the VBI data of the contents desired by the user are extracted (Step S28) and checks (Step S29). If it is checked that the VBI data extracted by the signal processing portion 3b are the VBI data of the contents desired by the user (in the case of YES in Step S29), the controller unit 6b stores the extracted VBI data in the memory 4b temporarily and records the same in the hard disk drive 7 (Step S210). On this occasion, it is possible to combine a plurality of the VBI data stored in the memory 4b and record as one or a plurality of contents in the hard disk drive 7, if necessary. When recording of the VBI data of the contents desired by the user in the hard disk drive 7 is finished, the controller unit 6b turns off power of the hard disk recorder B (Step S211). Thus, the hard disk recorder B records the contents desired by the user and then returns to a turned off state again.

The contents to be obtained as the VBI data include an EPG (Electronic Program Guide), news, weather forecast, traffic information and the like.

In the embodiment described above, the VBI data extraction display portion makes the secondary display after the data broadcast reception device A (or the hard disk recorder B) is turned on for extracting the VBI data superimposed on the video signal of the television broadcast and the data broadcast reception device A (or the hard disk recorder B) has finished the activation process. However, the present invention is not limited to this structure but can be applied to other structure that makes the secondary display in the state ready to extract the VBI data, in short. In addition, it is possible to stop the secondary display when it becomes disabled to receive the VBI data due to occurrence of a failure in synchronization or an unstable state of the system during reception of the VBI data. In addition, it is possible that the VBI data extraction display portion indicates a progress situation of the extraction of the VBI data. For example, it is possible to start the display when it becomes ready to extract the VBI data and a size of a bar display or the like is enlarged when the VBI data is extracted. Alternatively, it is possible to indicate the progress situation by using a numerical display.

In the embodiment described above, the data broadcast display portion 51 and the VBI data extraction display portion 52 are included in the display portion 5b of the data broadcast reception device A (or the hard disk recorder B). However, it is possible to arrange the data broadcast display portion 51 and the VBI data extraction display portion 52 separately from the display portion 5b by using an LED or the like, for example. In addition, it is possible to use an indicator that is capable of changing its display color so that the data broadcast display portion (primary display) and the VBI data extraction display portion (secondary display) correspond to different display colors of the same indicator. In this case, the number of indicators can be reduced.

In the embodiment described above, a concrete example of the case where the data broadcast reception device is the hard disk recorder is described. However, the present invention can be applied widely to image processing devices including a DVD recorder with a hard disk, a television set and a VTR without being limited to the above case. Alternatively, the present invention can also be applied to a special device for receiving data broadcast that is connected to the image processing device. In short, the present invention can be applied to a device that is capable of extracting the VBI data superimposed on the data television signal during the VBI. In the case of an image processing device such as a television set or a VTR, it is preferable that a recording device for recording the VBI data is provided.

What is claimed is:

1. A data broadcast reception device for extracting a data signal superimposed on a received television signal during the VBI, comprising:
a tuning portion for receiving a television signal;
a demodulating portion for demodulating the television signal received by the tuning portion;
a signal processing portion for extracting VBI data superimposed on a video signal included in the television signal demodulated by the demodulating portion during a VBI;
a primary display portion for making a primary display indicating that the data broadcast reception device is powered on for receiving the television signal and extracting the VBI data;
a secondary display portion for making a secondary display indicating that the data broadcast reception device has become a state ready to extract the VBI data;
a memory portion for memorizing a start time of extracting the VBI data; and
a controller unit for controlling the portions, wherein
the controller unit turns on power of the data broadcast reception device before it becomes the start time of extracting the VBI data memorized in the memory portion, lets the primary display portion make the primary display, performs an activation process of the portions, lets the secondary display portion make the secondary display after the activation process is completed, and lets the signal processing portion start extraction of the VBI data.

2. The data broadcast reception device according to claim 1, further comprising a recording device for recording the VBI data extracted by the signal processing portion on a recording medium, wherein after the secondary display portion makes the secondary display, the signal processing portion extracts the VBI data, while the recording device records the VBI data on the recording medium.

3. A hard disk recorder for extracting and recording VBI data superimposed on a received television signal during the VBI, comprising:
a tuning portion for receiving a television signal;
a demodulating portion for demodulating the television signal received by the tuning portion;
a signal processing portion for extracting VBI data superimposed on a video signal included in the television signal demodulated by the demodulating portion during a VBI;
a recording device for recording the extracted VBI data in a hard disk that is a recording medium;
a primary display portion for making a primary display indicating that the hard disk recorder is powered on for receiving the television signal and extracting the VBI data;
a secondary display portion for making a secondary display indicating that the hard disk recorder has become a state ready to extract and record the VBI data;
a memory portion for memorizing a start time of extracting the VBI data preset by a user; and
a controller unit for controlling the portions, wherein
the controller unit turns on power of the hard disk recorder before it becomes the start time of extracting the VBI data memorized in the memory portion, lets the primary display portion make the primary display, performs an activation process of the portions, lets the secondary display portion make the secondary display after the activation process is completed, and lets the signal processing portion start extraction of the VBI data so that the recording device records the VBI data.

4. A method for extracting VBI data superimposed on a received television signal during the VBI in a data broadcast reception device, comprising:
a memorizing step for memorizing a preset start time of extracting the VBI data;
a power on step for turning on power of the data broadcast reception device before it becomes the start time of extracting the VBI data memorized in the memorizing step;
a primary display step for making a primary display indicating that the data broadcast reception device is powered on for receiving the television signal and extracting the VBI data;
an activation step for performing an activation process of the data broadcast reception device;
a secondary display step for making a secondary display indicating that the activation process of the data broadcast reception device is completed;
a tuning step for receiving a television signal;
a demodulating step for demodulating the received television signal; and
a signal processing step for extracting the VBI data superimposed on the video signal of the demodulated television signal during the VBI.

5. The method according to claim 4, further comprising a recording step for recording the VBI data extracted in the signal processing step on a recording medium.

6. A method for extracting and recording VBI data superimposed on a received television signal during the VBI in a hard disk recorder, comprising:
a memorizing step for memorizing a start time of extracting the VBI data preset by a user;
a power on step for turning on power of the hard disk recorder before it becomes the start time of extracting the VBI data memorized in the memorizing step;
a primary display step for making a primary display indicating that the hard disk recorder is powered on for receiving the television signal and extracting the VBI data;
an activation step for performing an activation process of the hard disk recorder;
a secondary display step for making a secondary display indicating that the activation process of the hard disk recorder is completed;
a tuning step for receiving a television signal;
a demodulating step for demodulating the received television signal;
a signal processing step for extracting the VBI data superimposed on the video signal of the demodulated television signal during the VBI; and
a recording step for recording the extracted VBI data in a hard disk that is a recording medium.
